(19) United States
(12) Patent Application Publication
(10) Pub. No.: US 2011/0296843 A1
(43) Pub. Date: Dec. 8, 2011

(54) POSITIVE DISPLACEMENT POWER EXTRACTION COMPENSATION DEVICE

(76) Inventor: T. Towles Lawson, JR., Charlottesville, VA (US)

(21) Appl. No.: 12/794,075

(22) Filed: Jun. 4, 2010

(51) Int. Cl. F02C 7/26; F02C 6/04

(52) U.S. Cl. 60/778; 60/784

(57) ABSTRACT

A positive displacement power extraction compensation device is used to start and control the operation of engines. The device includes a positive displacement fixed vane compressor having a rotor connected with a drive shaft, a combustor connected with the compressor and a positive displacement power extraction device also having a rotor connected with a drive shaft. The compressor and power extraction devices are configured to displace unequal volumes of air at a given speed, so that combustion gases from the combustor exert less force on the compressor drive shaft as on the power extraction device drive shaft.

This application claims the benefit of U.S. provisional application No. 60/184,119 filed Jun. 4, 2009.

### FIELD OF THE INVENTION

The present invention relates to the substitution of positive displacement devices of a certain type for traditional compressors and turbines in gas turbines.

### BACKGROUND OF THE INVENTION

Gas turbines have three basic parts. In its simplest form, the three components are the compressor, the combustor and the turbine. Energy extracted from the turbine is used to drive the compressor, which compresses air so that it may be mixed with fuel and burned in the combustor. The burnt fuel then exits the combustor through the turbine which rotates in response. The turbine drives the compressor and ancillary components. The range of gas turbines from turbojets to turbo shafts is defined by how much energy is extracted as shaft power.

Turbojets extract as little energy as possible and still run various components. The primary design goal of a turbojet is to produce thrust. The exhaust gas from a turbojet travels extremely quickly and can be used to power a high speed device such as an older war plane.

Turbo fans and turbo props extract more power from the burning gases with additional turbine stages. The mechanical power is used to turn propulsion fans or propellers. There may be multiple turbines and some may rotate on shafts separate from the compressor shaft. The additional shafts may be used to drive devices at speeds somewhat independent of the primary shaft. A turbo shaft is designed to convert as much of the energy as possible into mechanical energy as shaft horsepower.

The main difference between a turbo prop and a turbo shaft is nomenclature. The hot gases exiting a turbo prop engine provide very little thrust. Instead, the energy in the burning gases is converted to mechanical energy which spins a much more efficient propeller. The combustor includes various components such as provisions for fuel injection and ignition. For various reasons explained below, it is not feasible to simply replace the compressors and turbines of a gas turbine with positive displacement devices and create a functioning engine. The goal of the present invention is to create a functioning analogous engine.

All gas turbines are dynamic devices rather than positive displacement devices. They move or are moved by air hitting the blades of the compressor and turbine wheels and reacting. Gases can move slowly though a stopped gas turbine easily. Gas turbines need the gas to move quickly through them to function. The amount of air the compressor of a gas turbine moves increases with the square of its speed. The compressor needs to spin at high speeds in order to compress air but there are factors which limit the operating speed range of a compressor.

The same factors which confine the operating range of the compressor also apply to the turbine. These factors are related to both the lift coefficient of the blades and the horsepower. The lift coefficient L is defined as

L=½pv²AC_{L}

where

p is air density,

v is the velocity of the gas for axial flow devices,

A is planform area. and

C_{L} is the lift coefficient at the desired angle of attack, Mach number and Reynolds number.

The gas horsepower varies by the cube of the speed for centrifugal fans according to the equation

GHP₂=GHP₁(RPM₂/RPM₁)³

where

GHP is the gas horsepower, and

RPM is the revolutions per minute of the fan.

Air velocity, pressure, heat, and the multitude of combinations of different sizes of devices make the design of gas turbines much more complicated than these formulas can begin to predict, but what is common to these devices is that they are efficient over an operating range which is in low multiples of their design speeds. This fact about gas turbines and compressors is what allows them to be started by being driven by a starter motor. The machine can be driven to a speed where the compressor provides enough air pressure for the fuel to be ignited in the combustor, but this speed is designed to be lower than the speed at which the turbine would act as a positive displacement fixed vane compressor and start to create a vacuum in the combustor. Once combustion is sustained, the volume of hot gasses is far greater than the volume being introduced by the compressor. The gasses generated by the combustor drive the turbine.

The present invention uses a positive displacement compressor, a combustor and a positive displacement expander downstream of the combustor. The expander may drive the compressor just like the turbine drives the compressor in a gas turbine. This type of machine has been called an open cycle engine and falls into to the category of Brayton cycle engines which are characterized by combustion which occurs continuously and at near constant pressure. Gas turbines are Brayton cycle engines which are in widespread use.

Internal combustion engines based on positive displacement compressors have historically not had constant combustion at constant pressure. Piston engines are examples of positive displacement engines, and the Wankle is another example. These reciprocating machines positively confine the charge gas and reduce its volume and then extract the energy as the volume increases during the expansion cycle.

It may be noted here that Roots blowers do not actually confine the volume of air they move, but rather they rely on back pressure against the outflow to provide a chamber in which there can be a pressure rise. If a Roots blower vents to atmosphere, no compression takes place. The fixed vane compressor which is used in the present invention shares this characteristic with the Roots blower and in this way is unlike traditional vane machines.

A common engine type is a hybrid of positive displacement engine and a gas turbine. The turbocharged reciprocating engine is a combination of two complete systems, a reciprocating engine and a gas turbine. The reciprocating engine serves as the combustor for the turbine. The only work the turbine does is to drive the compressor. Shaft power is only taken from the reciprocating engine. This combination is well adapted, with the aid of modern controls, to increase the power density of the reciprocating engine. The power from the exhaust gases is used only to provide greater air flow to the engine so that it can burn more fuel. Not as widely used is turbo compounding which is the use of a turbine in conjunction with a reciprocating engine to provide shaft power and not just compressed intake air. The goal of turbo compounding is to recover energy from the still expanding exhaust gas, and therefore increase shaft power, for a given amount of fuel, and therefore increase efficiency. An increase in power density is best served by turbocharging which makes the engine itself more powerful. Sometimes efficiency is also increased. Power density can be increased by using either a positive displacement device, such as a Roots blower, or a dynamic compressor, either one driven by shaft power from the engine.

Another hybrid of a dynamic compressor and a reciprocating engine is a supercharged engine where the blower is a centrifugal compressor. The efficiency of a centrifugal compressor is desirable but its operating range is so narrow that mechanical supercharging is almost universally done with a much less efficient positive displacement compressor, like a Roots blower. Because mechanically driven superchargers use shaft power, they do not take advantage of the energy in exhaust gas as a turbocharger does. The benefit of a supercharger is that there is no lag time, and the designer hopes that the overall efficiency of the vehicle can be maintained by having a greater power density and response than a similarly powerful naturally aspirated engine or turbocharged engine respectively.

The limited operating range of dynamic compressors and turbines contributes to turbo lag in turbocharged engines, limits the use of turbo-compounding so that gas turbines are best suited to applications where their manifold well known advantages outweigh their deficit of a narrow operating speed range.

A third and more pertinent hybrid of a positive displacement machine and a dynamic compressor is described in the Van Blaricom US patent application publication No. 2008/0087004. This open cycle engine incorporates a positive displacement device in place of the turbine, but uses a centrifugal compressor to supply air to the combustor. There is no reciprocating engine as part of the system. The centrifugal compressor can be replaced by another type of compressor such as an axial or mixed flow compressor. There is a compelling reason for such a hybrid layout, but it comes at a cost of efficiency and limited operating range. Many controls are required to effectively mate a dynamic compressor to a positive displacement device, and examples of these are the use of waste gates on turbochargers and the use of variable geometry turbochargers.

The preferred embodiment Van Blaricom includes a centrifugal air compressor which supplies air to the combustor with a positive displacement power extraction device placed downstream of the combustor. This arrangement has the advantage that if the components are properly sized, the engine can be started by spinning it with a starter motor. When the engine reaches a predetermined speed, fuel is introduced into the combustor and ignited. Because of the complicated but known characteristics of centrifugal compressors (and the other non-positive displacement compressors mentioned above), the compressor will deliver more air than the power extraction device draws out of the combustion chamber before ignition. Once the fuel is introduced and ignited and combustion is maintained, the volume of the gases drives the power extraction device which in turn drives the compressor.

Another embodiment suggested but not elaborated upon in Van Blaricom is one where two of the inventive positive displacement devices are used. One of the fixed vane devices is used as a power extraction device which is analogous to the turbine of a gas turbine. The second fixed vane device is the compressor. The second positive displacement device is analogous to the compressor of a gas turbine or the centrifugal compressor in the embodiment described above. Van Blaricom refers to the use of two fixed vane positive displacement devices, but does not explain some of the peculiarities of such a contrivance, nor does Van Blaricom contain information regarding the mechanisms necessary to overcome the corollary complications which result when positive displacement devices are used for both the compressor and the power extraction roles.

### SUMMARY OF THE INVENTION

The present invention is used during certain operating regimes and for starting an open cycle engine. The invention compensates for physical differences between positive displacement devices and the compressors and turbines found in gas turbine engines. These physical differences prevent operation of an engine which is similar to a gas turbine but uses positive displacement devices in place of both the compressor section and the turbine section.

An object of the present invention is to integrate a positive displacement device in the role of primary power extraction device in an engine where the role of compressor is assumed by a similar positive displacement device. This integration is mainly related to the relative size and speeds of the two devices. The integration also requires other mechanisms particular to this system for starting and enhanced transient response.

To achieve the above objective, the devices need to be connected to each other in such a way that the burning gases in the combustor take the path of least resistance through the power extraction device. If the PED (Power Extraction Device analogous to the turbine) is to drive the PDC (Positive Displacement Compressor analogous to the gas turbine compressor section) directly, then the PED must either be of a greater displacement, or, if they are the same size, the PED must be geared to run at higher revolutions per minute (RPM) than the PDC. Alternatively, the PED could be uncoupled from the PDC or coupled through a variable ratio transmission. The important point is that if the engine were built so that it moves equal volumes of air at a given RPM, the combustion gases exert as much force on the PDC shaft as on the PED shaft, assuming the same efficiency, and such a design would not work.

A design where the PED is of an effective greater displacement, whether because it displaces more per revolution or because it is geared to run faster than the PDC, poses a significant difficulty when starting the engine. When driven by a starter motor, before combustion, the PED causes a vacuum in the combustion chamber because the PED is moving more air out than the PDC supplies. Combustion cannot begin where a vacuum is being created.

It is therefore the object of the present invention to arrange the PDC and the PED relative to each other, and to provide a mechanism for overcoming the difficulties of starting and operating a device according to this design.

### BRIEF DESCRIPTION OF THE FIGURES

Other objects and advantages of the invention will become apparent from a study of the following specification when viewed in the light of the accompanying drawing, in which:

FIG. 1 is a block diagram of an engine starting and control system;

FIG. 2 is a detailed schematic view of the engine of FIG. 1; and

FIG. 3 is a block diagram of a preferred embodiment of an engine starting and control system according to the invention.

### DETAILED DESCRIPTION

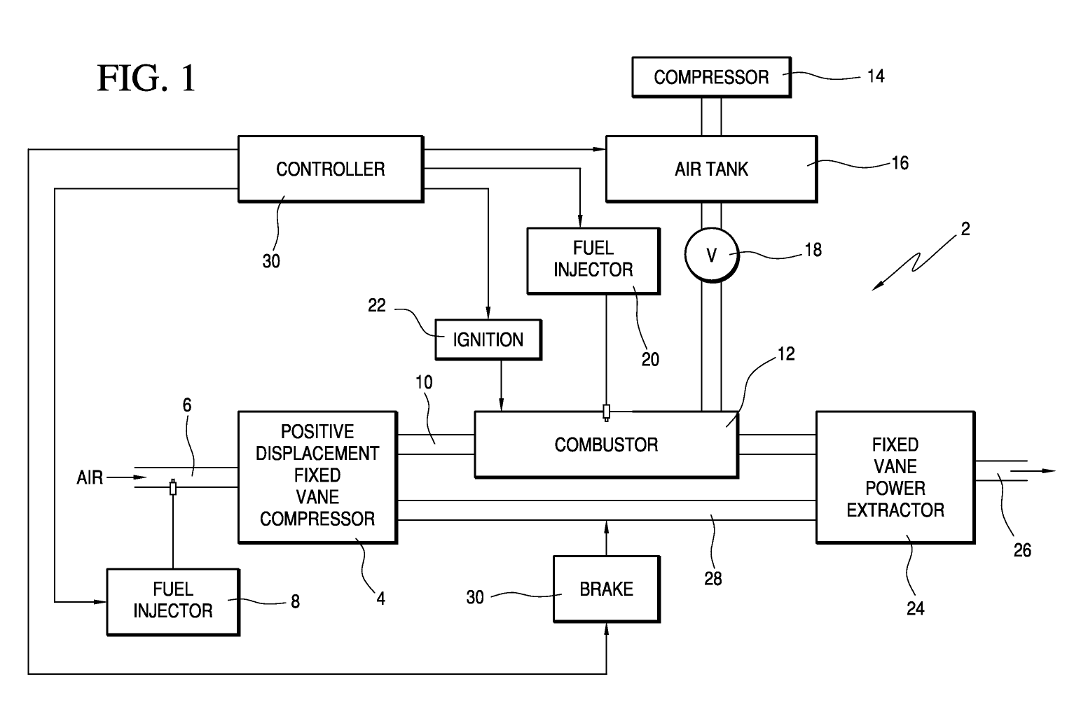

Referring first to FIG. 1, there is shown an engine 2 which includes a compressor in the form of a positive displacement fixed vane compressor 4. The positive displacement fixed vane compressor compresses air supplied to an inlet 6 of the compressor. A fuel injector 8 is also connected with the air inlet for injecting fuel into the air supply. A fluid conduit 10 connected with the compressor 4 delivers output fluid to a combustor 12. The combustor 12 further receives air for combustion of the fluid. More particularly, a compressor 14 provides pressurized air which is stored in a tank 16. A valve 18 meters the volume of air delivered from the tank to the combustor during starting of the engine, during periods of transient engine power, or during other periods where a low pressure in the combustor could adversely affect combustion. A fuel injector 20 injects fuel into the combustor and an ignition device 22 is connected with the combustor to initiate combustion of the air and fuel mixture. A fixed vane power extractor 24 is connected with the output of the combustor. The power extractor includes an exhaust outlet 26. Between the positive displacement fixed vane compressor 4 and the fixed vane power extractor 24 is a drive assembly 28 or other power transfer mechanism such as gears, belts or chains.

To start the engine, air from the tank 16 is introduced to the combustor 12 via air injection port. Fuel is injected into the combustor through fuel injector 20 and the ignition device 22 ignites the fuel. As combustion occurs, the pressure in the combustor increases. The hot gases from the combustor exit through the power extraction device 24. A separate starter motor (not shown) may be provided to spin the engine. The air from the supplemental air tank 16 tends to cause the rotors to spin in the correct direction, but delaying ignition until there is both positive pressure in the combustor and correct rotation of the engine is useful in most applications. A brake 30 is connected with the drive assembly 28 to control the speed of the engine 2. The brake may be of the friction, electric, hydraulic or pneumatic type.

A controller 32 is connected with the fuel injectors 8, 20, the ignition device 22 and the air tank 16 to control the delivery of fuel and air and the combustion thereof in the combustor to control the speed of the engine. In addition, the controller is connected with the brake 30 to further control engine speed.

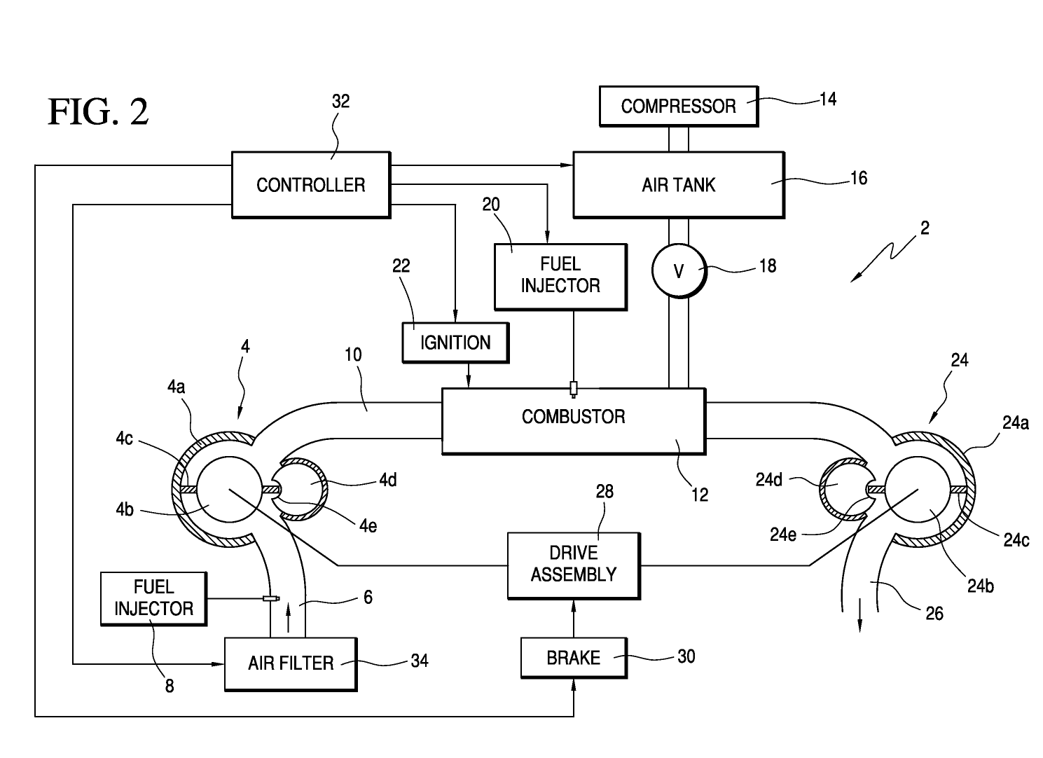

Referring now to FIG. 2, the positive displacement fixed vane compressor 4 and the fixed vane power extractor 24 according to FIG. 1 are shown in more detail. The compressor 4 includes a housing 4a in which a fixed vane mechanism rotates. The vane mechanism includes a rotor 4b having at least two vanes 4c mounted thereon. Air from the inlet 6 is filtered by an air filter 34. The air is forced by the vanes 4c as the rotor rotates within the housing. The rotating vanes intercept a second rotor 4d which contains a cutout portion 4e for receiving the vanes 4c of the first rotor 4b. The second rotor 4d is geared or otherwise timed to rotate in a direction counter to the direction of rotation of the first rotor. The power extractor 24 includes a housing 24a which contains a first rotor 24b having at least two vanes 24c mounted thereon. The rotor housing contains a second rotor 24d which contains a cutout portion 24e for receiving the vanes 24c of the first rotor 24b. The rotors of the power extractor thus counter rotate as do the rotors in the compressor.

In FIG. 2, the positive displacement fixed vane compressor 4 and the power extraction device 24 have the same displacement. In order for the path of least resistance for the output of the combustor 12 to be through the power extraction device 24, the positive displacement fixed vane compressor 4 spins more slowly than the power extraction device 24 of the same size. The rotors 4b, 24b of the compressor 4 and power extractor 24 are connected via the drive assembly 28. The gear ratio between the compressor and the power extraction device is such that if they are the same size, when they spin the power extraction device spins faster than the compressor.

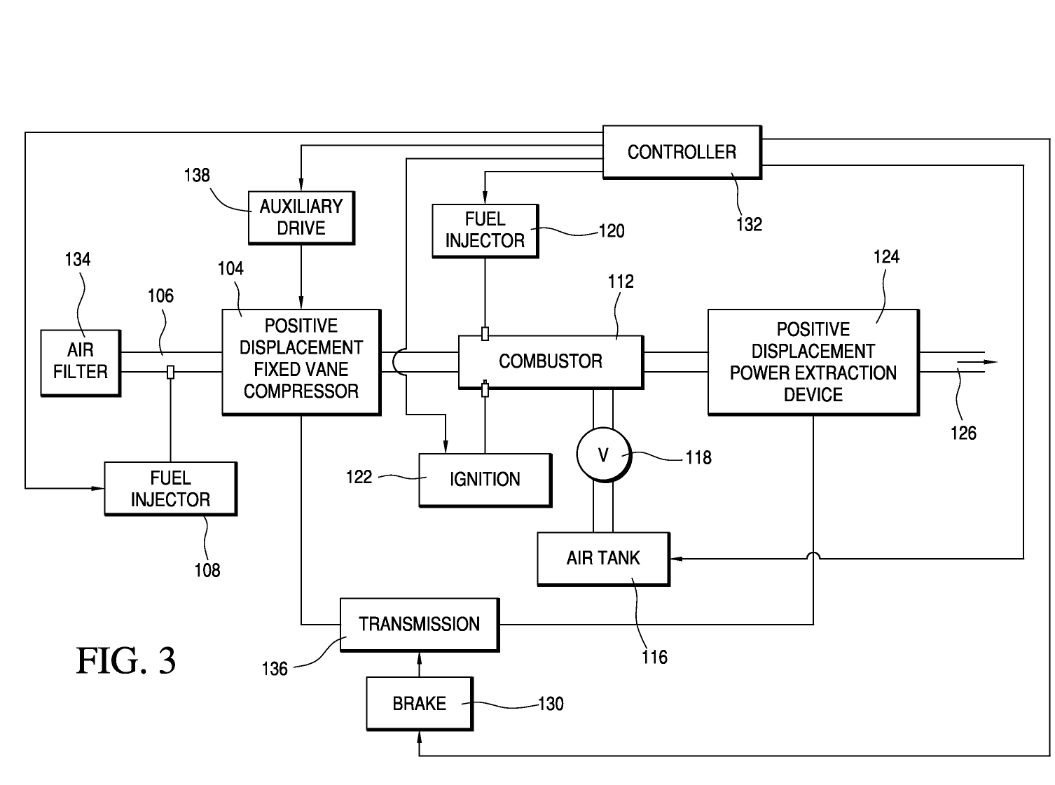

The preferred embodiment of the invention will now be described with reference to FIG. 3. This embodiment is similar to that of FIGS. 1 and 2 except that a positive displacement fixed vane compressor 104 is coupled with a positive displacement power extraction device 124 via the combustor. The devices are coupled so that the power extraction device drives the compressor at a 1:1 ratio. More particularly, the fixed vane compressor 4 includes an air inlet 106 which includes an air filter 134 for eliminating contaminants. A fuel injector 108 is connected with the air inlet 106. The fixed vane compressor is connected with a combustor 112 which receives fuel from a fuel injector 20 and air from an air tank 116 via a valve 118 which regulates the pressure of the air. An ignition device ignites the fuel within the combustor. The output of the combustor is connected with the positive displacement power extraction device 124 having any exhaust outlet 126. Since the power extraction device of FIG. 3 has a greater displacement, when there is pressure in the combustion chamber that is greater than the ambient air pressure, the gas in the combustion chamber exits through the power extraction device. This occurs even though it causes the power extraction device to drive the compressor to force air into the combustion chamber against the pressure already there. The exact size ratio depends on the application, but the size relationship will never be reversed.

A transmission assembly 136 is preferably connected between the positive displacement fixed vane compressor and the positive displacement power extraction device which allows the ratio between the compressor and the power extraction device to be varied. The transmission essentially replaces the drive assembly of FIGS. 1 and 2. If desired, a brake 130 can be connected with the transmission, although depending on the design of the transmission, the brake may not be necessary. The transmission may be mechanical, hydraulic, electric or pneumatic. In addition, an auxiliary drive mechanism 138 is connected with the compressor to spin the rotor of the compressor independently of the power extraction device. Operation of the compressor in this manner will generate positive pressure in the combustor. The auxiliary drive mechanism can be a motor or generator to spin the compressor rotor during start up and at other times when more air is required.

A controller 132 is connected with the fuel injectors 108, 120, the ignition device 122 and the air tank 116 to control the delivery of fuel and air and the combustion thereof in the combustor to control the speed of the engine. In addition, the controller is connected with the brake 130 to further control engine speed and with the auxiliary drive mechanism 138.

While the preferred forms and embodiments of the invention have been illustrated and described, it will be apparent to those of ordinary skill in the art that various changes and modifications may be made without deviating from the inventive concepts set forth above.

What is claimed is:

1. An engine starting and control system, comprising
(a) a positive displacement fixed vane compressor having a rotor;
(b) a combustor connected with said compressor;
(c) a positive displacement power extraction device connected with said combustor and having a rotor;
(d) means connecting said compressor rotor and with said power extraction device rotor, said compressor and said power extraction device being configured to displace unequal volumes of air at a given speed, whereby combustion gases from said combustor exert less force on said compressor rotor as on the power extraction device rotor; and
(e) an auxiliary air supply connected with said combustor for supplying air under pressure to said combustor to facilitate combustion.

2. An engine starting and control system as defined in claim 1, wherein said connecting means comprises a drive assembly for connecting said power extraction device directly with said compressor to drive said compressor.

3. An engine starting and control system as defined in claim 2, wherein said power extraction device and said compressor are the same size.

4. An engine starting and control system as defined in claim 2, wherein the displacement of said power extraction device is greater than the displacement of said compressor.

5. An engine starting and control system as defined in claim 2, and further comprising a first fuel injector connected with said combustor.

6. An engine starting and control system as defined in claim 5, and further comprising a controller connected with said first fuel injector and said auxiliary air supply to control the combustion of fuel in said combustor in order to regulate the speed of the engine.

7. An engine starting and control system as defined in claim 6, and further comprising an ignition device connected with said combustor and with said controller for controlling the ignition of fuel within the combustor.

8. An engine starting and control system as defined in claim 7, and further comprising a second fuel injector connected with an input to said positive displacement fixed vane compressor.

9. An engine starting and control system as defined in claim 1, wherein said auxiliary air supply includes a compressor, an air tank for receiving air under pressure from said compressor, and a valve connected with said air tank for controlling the pressure of air delivered to said combustor.

10. An engine starting and control system as defined in claim 1, wherein said connecting means comprises a transmission connected between said to vary the drive ratio between said compressor and said power extraction device.

11. An engine starting and control system as defined in claim 1, and further comprising an auxiliary drive mechanism connected with said compressor for spinning said compressor rotor when said power extraction device rotor is stationary to generate positive pressure within said combustor.

12. An engine starting and control system as defined in claim 2, and further comprising a brake connected with said drive assembly for controlling the speed of said power extraction device to prevent it from creating low pressure within said combustor.
